(19) United States
(12) Patent Application Publication
(10) Pub. No.: US 2005/0008458 A1
(43) Pub. Date: Jan. 13, 2005

(54) Biased fastening system

(76) Inventors: Nancy Kay Keech, Mission Viejo, CA (US); Gary James William Grodeman, Phoenix, AZ (US)

Correspondence Address: BARNES & THORNBURG, P.O. BOX 2786, CHICAGO, IL, 60690-2786, US

(21) Appl. No.: 10/857,309

(22) Filed: May 28, 2004

Related U.S. Application Data
(60) Provisional application No. 60/474,786, filed on May 30, 2003.

(51) Int. Cl. F16B 21/00

(52) U.S. Cl. 411/555

(57) ABSTRACT

A fastening system for removably attaching a first work piece having a first aperture in biased engagement with a second work piece having a second aperture. The fastening system includes a receptacle having a housing that forms a chamber. A cap is attached to the housing by a retainer member and is slidable with respect to the housing between extended and retracted positions. One or more generally conical-shaped spring washers resiliently bias the cap toward the extended position with a preload biasing force. The fastening system includes a fastener having a spiral slot that is adapted to be inserted into the chamber. The spiral slot is adapted to receive the retainer member. When the fastener is rotated, the spiral slot of the fastener slides the end cap from the extended position toward the retracted position and compresses the biasing members such that the biasing members provide a resilient biasing force for biasing the second work piece in engagement with the first work piece.

### RELATED APPLICATIONS

This application claims the benefit of U.S. Provisional Application No. 60/474,786, filed May 30, 2003.

### BACKGROUND

The biased fastening system of the present disclosure includes a fastener and a receptacle that are adapted to removably attach a first work piece in biased engagement with a second work piece, wherein the fastening system includes one or more spring washers that are adapted to bias the work pieces together and wherein the fastener may include a resiliently biased detent member to selectively retain the fastener in engagement with the second work piece.

A variety of fastener systems have been developed which include a fastener and a receptacle. Generally, the receptacle is attached to a first work piece and the fastener is associated with a second work piece. The fastener and the receptacle may be configured such that the fastener can be attached to the receptacle or released from the receptacle with a quarter turn of the fastener. In this regard, Hartwell-Dzus, Inc., the assignee of the present disclosure, has developed such fastener systems. The present disclosure overcomes some of the limitations associated with the prior art fastener systems that include S-shaped coiled springs. In this regard, one of the possible limitations, depending on the application of the fastening system, is that the prior art S-shaped coiled spring design may result in the yielding and fatigue of the material from which the coiled spring is manufactured. Additionally, it may have been difficult to retain the fastener in association with the second work piece, and as a result, the fastener may have been prone to be inadvertently removed from the second work piece and possibly misplaced.

Additional features of the present disclosure will become apparent to those skilled in the art upon consideration of the following detailed description of the drawings.

### SUMMARY

A fastening system for removably attaching a first work piece having a first aperture in biased engagement with a second work piece having a second aperture. The fastening system includes a receptacle having a housing. The housing includes a central axis and a side wall forming a chamber. The side wall extends between a first end and a second end, and includes one or more apertures. A cap extends around the side wall and is selectively slidable along the central axis with respect to the side wall. A retainer member extends through the one or more apertures in the side wall and slidably couples the cap to the side wall. The retainer member is movable within the apertures of the side wall such that the retainer member and the cap are selectively conjointly slidable along the central axis between an extended position and a retracted position. One or more biasing members extend around said side wall. By ways of example, but not limitation, each biasing member may comprise a spring washer. The biasing members resiliently bias the retainer member and the cap toward the extended position. The receptacle is adapted to engage the first work piece.

The fastening system includes a fastener having a head and a body attached to the head.

The body includes a spiral slot adapted to selectively receive and retain the retainer member. The body of said fastener is adapted to be inserted through the second aperture of the second work piece, through the first aperture of the first work piece, and into the chamber of the receptacle wherein the retainer member is adapted to be located within the spiral slot of the body. When the fastener is rotated, the spiral slot of the body slides the retainer member and the cap from the extended position toward the retracted position thereby connecting the second work piece to the first work piece and compressing the biasing members. The biasing members thereby provide a resilient biasing force for biasing the second work piece in engagement with the first work piece.

### BRIEF DESCRIPTION OF THE FIGURES

FIG. 1 is a perspective view of the biased fastening system showing a receptacle with a first work piece and a fastener with a second work piece.

FIG. 2 is a bottom view of the receptacle as shown in FIG. 1.

FIG. 3 is a cross-sectional, side elevational view taken along line 3-3 of FIG. 2.

FIG. 4 is an exploded perspective view of the receptacle of FIG. 1.

FIG. 5 is a side elevational view of another embodiment of the receptacle.

FIG. 6 is a bottom view of the receptacle of FIG. 5.

FIG. 7 is an exploded perspective view of a portion of the receptacle of FIG. 5.

FIG. 8 is a cross-sectional perspective view of the receptacle of FIG. 5 taken along line 8-8 in FIG. 6.

FIG. 9 is an exploded perspective view of the fastener of the present disclosure.

FIG. 10 is a side elevational view of the fastener.

FIG. 11 is a top plan view of the fastener taken along line 11-11 of FIG. 10.

FIG. 12 is a cross-sectional, side elevational view taken along line 12-12 of FIG. 10.

FIG. 13 is a perspective view of a fastener in another embodiment of the biased fastening system.

FIG. 14 is an exploded perspective view of the fastener of FIG. 13.

FIG. 15 is a perspective view of the biasing mechanism of the fastening system of FIG. 13.

FIG. 16 is an exploded view of a receptacle of the fastening system of FIG. 13.

FIG. 17 is a top plan view of the receptacle of FIG. 16.

FIG. 18 is a cross-sectional, side elevational view taken along line 18-18 of FIG. 17.

FIG. 19 is a cross-sectional perspective view of another embodiment of the fastening system showing a fastener assembly and a receptacle.

FIG. 20 is a perspective view of a modified embodiment of the fastener assembly of FIG. 19.

FIG. 21 is a cross-sectional perspective view of a further embodiment of the fastener assembly shown with a receptacle.

### DETAILED DESCRIPTION

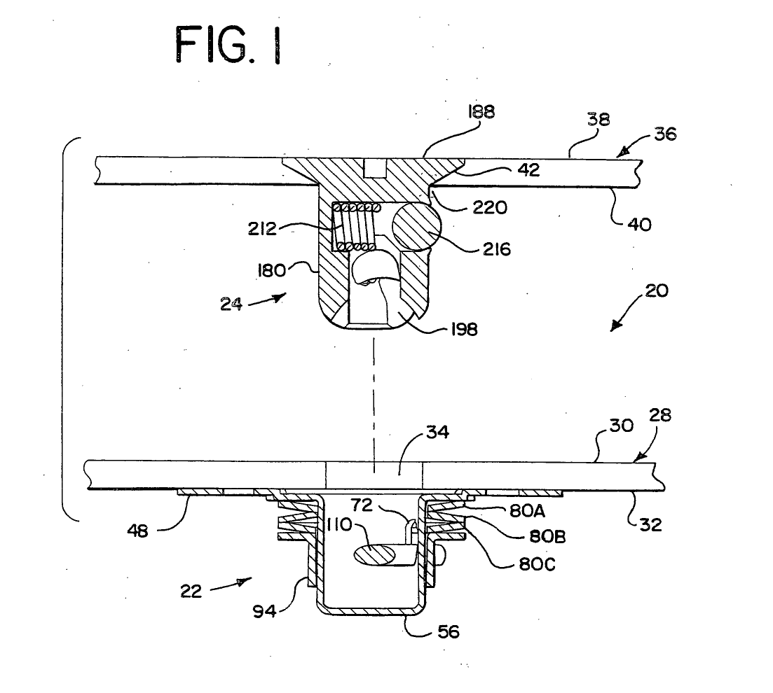

The biased fastening system 20 of the present disclosure, as shown in FIG. 1, includes a receptacle 22 and a fastener 24. The receptacle 22 is adapted to be attached to a first work piece 28, such as a plate, housing or the like, having a generally planar first surface 30 and a spaced apart and parallel second planar surface 32. The first work piece 28 includes a generally circular aperture 34. The fastener 24 is associated with and is removably attached to a second work piece 36, such as a plate, housing or the like, having a generally planar first surface 38 and a spaced apart and generally parallel second planar surface 40. The second work piece 36 includes a generally circular aperture 42 that may be countersunk as shown in FIG. 1. The apertures 34 and 42 are adapted to receive the fastener 24. The fastener 24 is adapted to be releasably secured to the receptacle 22 to thereby releasably attach the second work piece 36 in biased engagement to the first work piece 28. The work pieces 28 and 36 may respectively be formed from metallic and/or non-metallic materials including by way of example, but not limitation, steel, stainless steel, all steel alloys, aluminum, all aluminum alloys, titanium, all titanium alloys, plastic, and composite materials including graphite, carbon, quartz, glass, polymers, and cellulose.

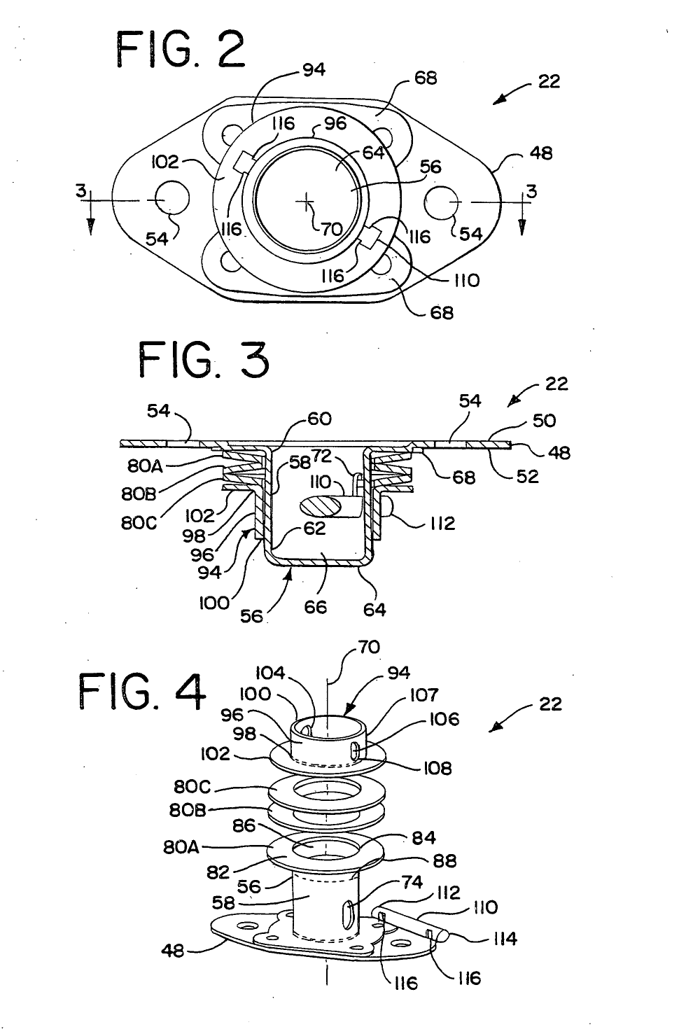

As shown in FIGS. 2 through 4, the receptacle 22 includes a generally plate-like base member 48. The base member 48 includes a generally planar first surface 50 and a spaced apart and parallel generally planar second surface 52. The base member 48 includes one or more apertures 54 for use in attaching the base member to a surface of the first work piece 28 with fasteners, such as threaded fasteners, rivets and the like. A housing 56 is attached to the second surface 52 of the base member 48. The housing 56 includes a generally cylindrical side wall 58 that extends between a first end 60 and a second end 62. A generally planar and circular end wall 64 is attached to the second end 62 of the side wall 58 such that the second end 62 of the side wall 58 is closed by the end wall 64. The side wall 58 and the end wall 64 form a hollow chamber 66 within the housing 56. The housing 56 also includes one or more flanges 68 that are attached to, and that extend outwardly from, the first end 60 of the side wall 58 generally perpendicular to a central axis 70 of the receptacle 22. The flanges 68 are attached to the second surface 52 of the base member 48. The housing 56 includes a first aperture in the form of a first elongate slot 72 that is formed in the side wall 58, and a second aperture in the form of a second elongate slot 74 that is formed in the side wall 58 generally diametrically opposite to the first elongate slot 72 with respect to the central axis 70. The slots 72 and 74 are elongate in a direction generally parallel to the central axis 70 and generally perpendicular to the base member 48. Each slot includes an inner end located toward the first end 60 of the side wall 58 and an outer end located toward the second end 62 of the side wall 58.

The receptacle 22 also includes one or more resilient biasing members such as spring washers, Belleville washers, wave washers. While the terms “spring washer”, “Belleville washers” and “wave washers” are used it is intended that these terms be broadly defined and interpreted to include, without limitation, a wide range of biasing members. As shown in FIGS. 3 and 4, the receptacle 22 includes three conical spring washers 80A-C, such as Belleville washers. Each conical spring washer 80A-C includes a generally annular disc 82 having a generally circular inner peripheral edge 84 that forms a generally circular central aperture 86, and a generally circular outer peripheral edge 88. The annular disc 82 of each washer 80A-C is generally conical in shape such that the outer peripheral edge 88 forms a conical base and the inner peripheral edge 84 forms a conical tip. The inner peripheral edge 84 is located in a first plane that is spaced apart from and parallel to a second plane which contains the outer peripheral edge 88. The central aperture 86 of the washers 80A-C is sized to closely receive the side wall 58 of the housing 56. The washer 80A is placed around the side wall 58 of the housing 56 such that its outer peripheral edge 88 engages the flange 68 and thereby the base member 48. The washer 80B is placed around the side wall 58 of the housing 56 such that the inner peripheral edge 84 of the washer 80B engages the inner peripheral edge 84 of the washer 80A. The washer 80C is placed around the side wall 58 of the housing 56 such that the outer peripheral edge 88 of the washer 80C engages the outer peripheral edge 88 of the washer 80B. The washer 80B is thereby inverted with respect to the washers 80A and 80C. The spring washers are thereby stacked in an accordion-like manner. One or more washers may also be stacked in a nested arrangement with the conical tip of a first washer being inserted within the annular disc of a second washer, such that the annular discs of the washers are in engagement with one another. Fewer or additional washers can be used as desired. When a washer 80A-C is subjected to an axial compressive force generally parallel to the central axis 70 it will resiliently deform into a somewhat flattened configuration, and when the force is removed the washer will resiliently return to its initial conical configuration. The stacking arrangement of the spring washers 80A-C about the housing 56 enables ease of assembly of the receptacle 22.

The receptacle 22 also includes a cap 94. The cap 94 includes a generally cylindrical side wall 96 having a first end 98 and a second end 100. The side wall 96 forms a bore and is adapted to closely receive the side wall 58 of the housing 56. A generally circular and annular flange 102 extends outwardly from the first end 98 of the side wall 96 generally perpendicular to the side wall 96. The flange 102 is adapted to engage the inner peripheral edge 84 of the washer 80C. The outer peripheral edge of the flange 102 has approximately the same diameter, or a slightly larger diameter, than the outer peripheral edges 88 of the spring washers 80A-C. The side wall 96 of the cap 94 includes a first aperture in the form of an elongate keyhole-shaped slot 104 and a second aperture in the form of an elongate keyhole-shaped slot 106 diametrically opposed to the first slot 104. The first slot 104 of the cap 94 is adapted to align with the first elongate slot 72 of the housing 56, and the second slot 106 of the cap 94 is adapted to align with the second elongate slot 74 of the housing 56. The keyhole slots 104 and 106 each include an enlarged portion 107 located toward the second end 100 of the side wall 96, and a reduced portion 108 located toward the first end 98 of the side wall 96. The enlarged portion 107 has a larger width than the reduced portion 108.

The receptacle 22 includes a retainer member such as a pin 110 that extends generally linearly between a first end 112 and a second end 114. The pin 110 may be generally cylindrical in cross section. The pin 110 extends through the first and second slots 104 and 106 of the cap 94, and through the first and second slots 72 and 74 of the housing 56, to thereby slidably couple the cap 94 to the housing 56. The ends 112 and 114 of the pin 110 project radially outwardly beyond the side wall 96 of the cap 94. The pin 110 thereby extends diametrically across the chamber 66 of the housing 58 generally perpendicular to the central axis 70. Each end 112 and 114 of the pin 110 includes one or more locking members 116. Each locking member 116 comprises a generally linear locking groove formed in the pin 110 that extends transversely to the central longitudinal axis of the pin 1 10. As shown in FIGS. 2 and 4, each end of the pin 110 includes two locking members 116, each comprising a respective locking groove. The locking grooves are located parallel to one another on diametrically opposite sides of the pin 110. The outer diameter of the pin 110 is sized to fit within the enlarged portion 107 of the slots 104 and 106, such that the pin 110 can be linearly inserted and removed from the cap 94 through the slots 104 and 106 when the pin 110 is located in the enlarged portions 107 of the slots 104 and 106. When the pin 110 is moved into the reduced portions 108 of the slots 104 and 106, the side wall 96 of the cap 94 extends inwardly into each groove that comprises a locking member 116, such that the locking members restrain movement of the pin 110 along its longitudinal axis, while the locking members 11 6 allow the pin 110 to move transversely to its longitudinal axis between the enlarged portions 107 and reduced portions 108 of the slots 104 and 106. The locking members 116 may also be formed as annular grooves.

The cap 94 is adapted to slide linearly along the central axis 70 with respect to the housing 54, while the pin 110 prevents undesired removal of the cap 94 from the housing 56. The cap 94 also retains the spring washers 80A-C in a stacked position about the housing 56 and between the cap 94 and base member 48. The spring washers 80A-C resiliently bias the cap 94 outwardly away from the base member 48 along the central axis 70 with a preloaded force to a fully extended position wherein the pin 110 engages the outer ends of the slots 72 and 74 of the housing 56. The magnitude of the preloaded force with which the spring washers 80A-C bias the cap 94 when the cap is in the extended position can be varied or tuned as desired by varying the biasing force of spring washers 80A-C that are used. The biasing force of the washers may be selected depending on the biasing force desired in the system. The biasing force of the washer may be attributable to any of many characteristics such as the manufacturer's method, choice of materials, etc. The preloaded biasing force may also be selectively varied by increasing the number of spring washers that are used to increase the magnitude of the preloaded force, or by decreasing the number of spring washers that are used to decrease the magnitude of the preloaded force.

The preloaded biasing force provided by the spring washers 80A-C maintains the pin 110 in the reduced portion 108 of the keyhole slots 104 and 106 in the cap 94, such that the pin 110 is locked to the cap 94. The pin 110 can be moved into the enlarged portions 107 of the slots 104 and 106 for removal by pressing the cap 94 toward the base member 48 while the mounting the pin 110 remains stationary, such that the pin 110 becomes aligned with the enlarged portions 107 of the keyhole slots 104 and 106. The components of the receptacle 22 are preferably made from metal and/or non-metal materials such as steel, stainless steel, all steel alloys, aluminum, all aluminum alloys, titanium, all titanium alloys, plastic, and composite materials including graphite, carbon, quartz, glass, polymers and cellulose. The receptacle 22 is adapted to replace prior receptacles having S-shaped coiled springs.

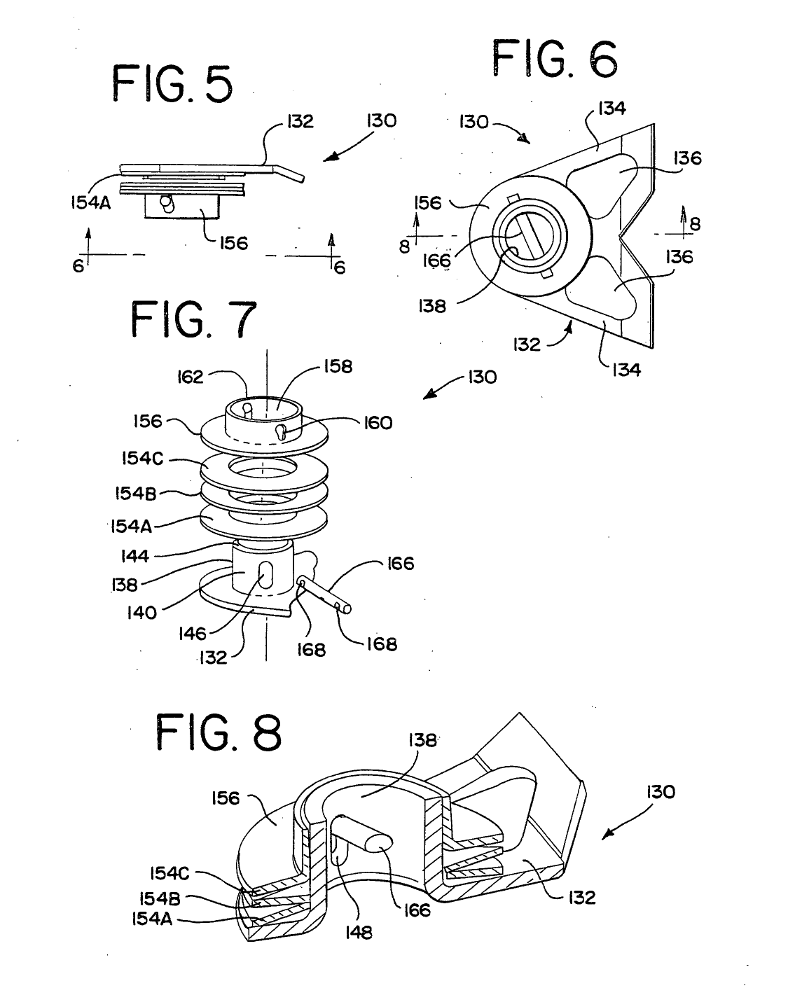

Another embodiment of the receptacle of the fastening system of the present disclosure is shown in FIGS. 5 through 8 and is identified with the reference number 130. The receptacle 130 includes a base member 132 having outwardly extending legs 134. Each leg 134 includes an aperture 136 and an inclined end portion. The base member 132 of the receptacle 130 is adapted to be attached to the first work piece 28 by welding, although it could also be attached by various types of fasteners. The base member 132 is adapted to provide substantial lengths of linear edges for welding. The receptacle 130 includes a housing 138 having a generally cylindrical side wall 140 that extends between a first end 142 and a second end 144. The first end 142 is attached to the base member 132. The side wall 140 includes a first aperture in the form of a first elongate slot 146, and a second aperture diametrically opposed to the first elongate slot 146 in the form of a second elongate slot 148. The slots 146 and 148 are elongate in a direction generally parallel to a central axis that extends through the housing 138. The second end 144 of the housing 138 forms a circular opening.

The receptacle 130 includes one or more conical spring washers 154A-C, such as Belleville washers, that are constructed and that operate in the same manner as the spring washers 80A-C. The spring washers 154A-C are located about the side wall 140 of the housing 138 in a stacked arrangement. The receptacle 130 also includes a cap 156 that is constructed in the same manner as the cap 94. The cap 156 includes a generally circular side wall 158 adapted to fit closely around the side wall 140 of the housing 138. The side wall 158 includes diametrically opposed keyhole-shaped apertures 160 and 162 that are adapted to align with the slots 146 and 148 of the housing 138. A pin 166 extends through the keyhole slots 160 and 162 in the cap 156, and through the slots 146 and 148 of the housing 138, to thereby slidably connect the cap 156 to the housing 138. Each end of the pin 166 includes one or more locking members 168, such as a groove. The pin 166, cap 156 and spring washers 154A-C operate in the same manner as the cap 94, pin 110 and spring washers 80A-C of the receptacle 22.

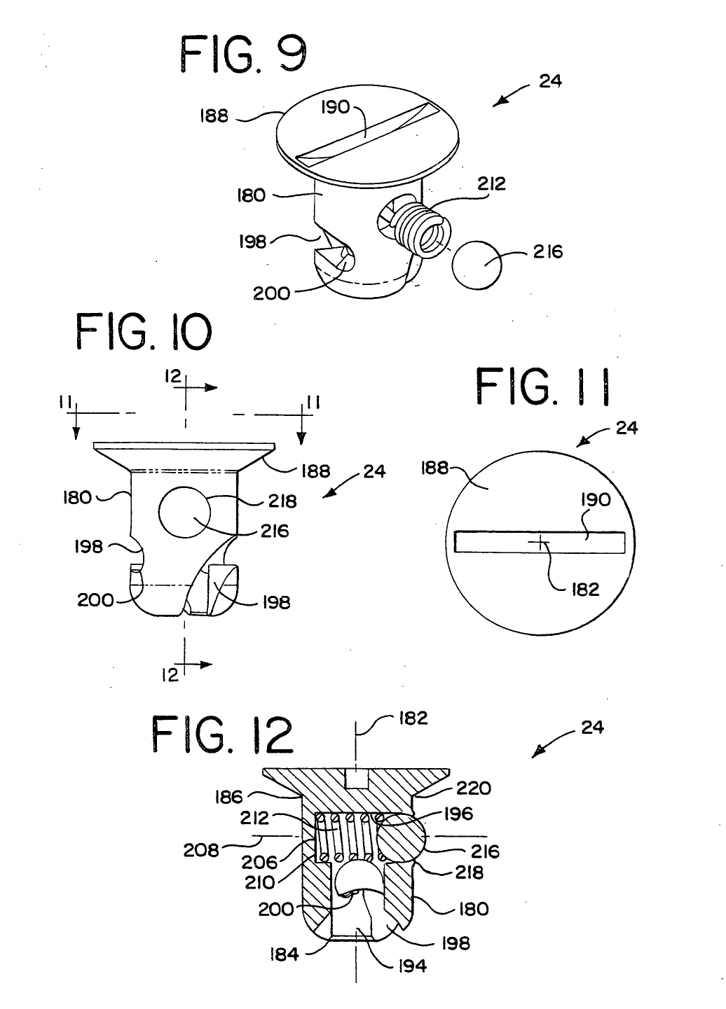

The fastener 24, as shown in FIGS. 9 through 12, comprises a stud including a generally tubular and cylindrical stud body 180 having a central longitudinal axis 182. The stud body 180 extends between a first end 184 and a second end 186. The second end 186 of the body 180 is attached to the undersurface of a head 188. The head 188 is larger in diameter than the body 180. The top surface of the head 188 includes a tool-receiving recess 190, such as an elongate linear channel as shown in FIG. 11. The recess 190 may be formed as a hexagonal-shaped socket, as a cross-shaped recess, or in various other configurations as desired. The head 188 may have a countersunk configuration as shown in FIG. 10. The head may be formed in various other configurations that provide an obstruction for preventing the stud body 180 from passing through an aperture. The stud body 180 includes a longitudinal bore 194 that extends into the body 180 along the axis 182 from the first end 184 to an interior end wall 196. The body 180 also includes a pair of spiral cam slots 198 that extend through the side wall of the body 180 to the bore 194, and that extend from the first end 184 of the body 180 to a locking detent 200. The spiral cam slots 198 are diametrically opposed to one another.

The body 180 also includes a transverse bore 206 that extends through a side wall portion of the body 180 and partially into the opposing side wall portion of the body 180 along a central transverse axis 208 that is perpendicular to, and that intersects with, the longitudinal axis 182. The transverse bore 206 forms an internal pocket 210 within a side wall portion of the body 180 that is adapted to receive a first end of a resilient biasing member 212, such as a helical spring. The transverse bore 206 forms a detent cavity 214 in a side wall portion of the body 180 diametrically across from the internal pocket 210. A detent member 216, such as a generally spherical ball, is located within the detent cavity 214. The diameter of the detent member 216 is larger than the thickness of the wall portion of the body 180. The detent cavity 214 includes a generally circular lip 218 that is adapted to retain the detent member 216 within the detent cavity 214.

A second end of the biasing member 212 engages the detent member 216. While the second end of the biasing member 212 usually remains in engagement with the detent member 216, the biasing member 212 is shown in FIG. 1 in a compressed or retracted position to illustrate the distance the detent member 216 can retract into the body 180. The biasing member 212 is adapted to resiliently bias the detent member 216 to an extended position as shown in FIG. 12, wherein a portion of the detent member 216 extends outwardly beyond the outer surface of the body 180. A seat 220 is thereby formed between the outwardly extending portion of the detent member 216 and the undersurface of the head 188. The seat 220 is adapted to receive and retain the second work piece 36 as shown in FIG. 1. The biasing member 212 allows the detent member 216 to be moved inwardly along the axis 208 from the extended detent position, as shown in FIG. 12, to a retracted position wherein the detent member 216 is located substantially entirely within the body 180. The transverse bore 206, internal pocket 210, detent cavity 214, biasing member 212, and detent member 216 are located within the body 180 adjacent the second end 186 of the body 180, substantially between the spiral cam slots 198 and the head 188. All of the components of the fastener 24 are preferably made from metal and/or non-metal materials, including by way of example, but not limitation, steel, stainless steel, all steel alloys, aluminum, all aluminum alloys, titanium, all titanium alloys, plastic, and composite materials including graphite, carbon, quartz, glass, polymers, and cellulose. It may be desirable to make all of the components of the receptacle 22 and fastener 24 from the same type of material from which the work pieces 28 and 36 are made for enhanced performance.

In operation, the first end 184 of the body 180 of the fastener 24 is inserted through the aperture 42 of the second work piece 36. The detent member 216 is pushed inwardly along the axis 208 to the retracted position within the body 180 such that the detent member 216 passes through the aperture 42 of the second work piece 36. Once the detent member 216 passes through the aperture 42, the biasing member 212 biases the detent member 216 to the extended position as shown in FIG. 1, wherein the second work piece 36 is located and retained within the seat 220 between the detent member 216 and head 188. The head 188 acts to positively retain the fastener 24 to the second work piece 36 while the detent member 216 releasably retains the fastener 24 in connection with the second work piece 36. The fastener 24 can be selectively removed from the work piece 36 by retracting the detent member 216 inwardly into the detent cavity 214 such that the detent member 216 will pass through the aperture 42 of the second work piece 36.

When the fastener 24 is coupled to the second work piece 36 as shown in FIG. 1, the first end 184 of the body 180 is inserted through the aperture 34 of the first work piece 28 and into the chamber 66 of the housing 56 along the axis 70 until the second surface 40 of the second work piece 36 is in abutting engagement with the first surface 30 of the first work piece 28. The pin 110 is then located within the outer ends of the spiral cam slots 198. A tool, such as a screwdriver, is then placed in the recess 190 in the head 188 of the fastener 24, and the fastener 24 is rotated about the axis 182 approximately ninety degrees, one-quarter turn, in a clockwise direction as viewed in FIG. 11. As the fastener 24 is rotated, the spiral cam slots 198 pull the pin 110 upwardly along the spiral cam slots 198 and along the axis 70 until the pin 110 is located in the locking detents 200 of the spiral cam slots 198, such that the fastener 24 is releasably connected to the receptacle 22. As the pin 110 is pulled upwardly into the locking detents 200, the fastener 24 also pulls the cap 94 from the extended position, as shown in FIG. 3, to a retracted position wherein the pin 110 is spaced apart from the outer ends of the elongate slots 72 and 74 of the housing 56. As the cap 94 slides along the axis 70 with respect to the housing 56, from the extended position to the retracted position, the cap 94 resiliently compresses the spring washers 80A-C.

When the fastener 24 is connected to the receptacle 22, the cap 94 is in the retracted position thereby further compressing the spring members 80A-C beyond the preloaded compression. The spring washers 80A-C thereby exert a resilient biasing force on the cap 94 and pin 110 in a direction parallel to the axis 70 and outwardly away from the base member 48 that is larger in magnitude than the preloaded biasing force the spring washers 80A-C exert on the cap 94 when the cap 94 is in the extended position. The spring washers 80A-C thereby resiliently bias the cap 94, pin 110 and the fastener 24 in a direction toward the second end 62 of the side wall 58 of the housing 56, such that the spring washers 80A-C resiliently bias the second work piece 36 into engagement with the first work piece 28. The conical spring washers 80A-C operate in the elastic range of the material that forms the washers, such that the washers will resiliently return to their original configuration after deformation due to compression by retraction of the cap 94 and without the material of the washers being subject to fatigue. The conical spring washers thereby eliminate the yielding and permanent deformation that may occur in S-shaped coil springs of prior art receptacles. The magnitude of the biasing force with which the fastener 24 and receptacle 22 bias the second work piece 36 into engagement with the first work piece 28 can be varied as desired by varying the size and stacking configuration of spring washers 80A-C that are used in the receptacle 22. The conical spring washers 80A-C provide a dampening effect with regard to relative movement of the work pieces and of the components of the fastening system thereby providing an increase in wear life.

As an example, the spring washers 80A-C can be stacked in series such that twenty-eight pounds of force is required to compress the washers by 0.040 inch, and fifty-four pounds of force is required to compress the washers a further 0.020 inch. The respective thickness of the spring washers 80A-C may be varied to provide different selected biasing forces. For example, the spring washers 80A-C may have respective thicknesses of 0.015 inch, 0.012 inch and 0.012 inch; 0.012 inch, 0.012 inch and 0.012 inch; or 0.015 inch, 0.015 inch and 0.012 inch.

The second work piece 36 can be released from the first work piece 28 by rotating the fastener 24 in a counterclockwise direction one-quarter turn about the axis 182 to release the pin 166 from the locking detents 200 and thereby release the fastener 24 from the receptacle 22. The fastener 24 may then be removed from the receptacle 22, such that the second work piece 36 can be removed from the first work piece 38. As the fastener 24 is removed from the receptacle 22 and the detent member 216 is removed from the aperture 34 of the first work piece 28, the detent member 216 of the fastener 24 will be biased to the extended position by the biasing member 212 such that the detent member 216 will retain the fastener 24 to the second work piece 36 as it is removed from the first work piece 28.

The receptacle 130 operates in connection with the fastener 24 in the same manner as the receptacle 22. The fastener 24 can be used in connection with various types of receptacles other than those as described herein. Similarly, the receptacles 22 and 130 as described herein can be used in connection with various types of fasteners other than the fastener 24 as described herein.

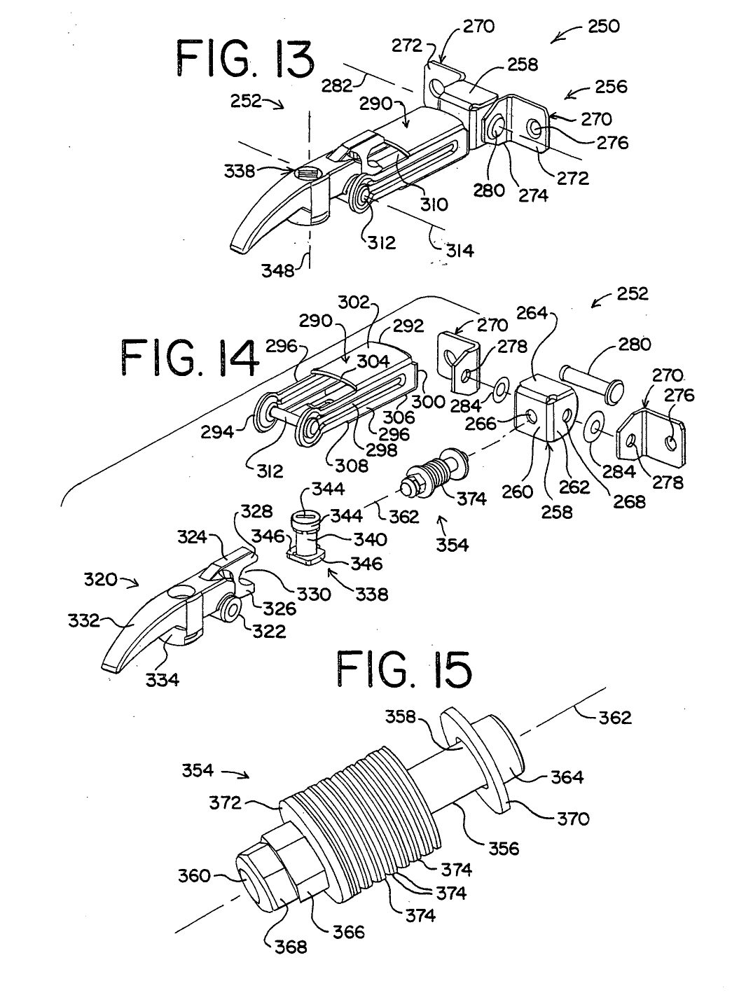

Another embodiment of the biased fastening system is shown in FIGS. 13-18 and is identified with the reference number 250. The fastening system 250 includes a fastener 252 and a receptacle 254. The fastener 252 includes a mounting member 256 that is adapted to be attached to a first work piece. The mounting member 256 includes a bracket 258 having a cavity formed by an end wall 260, two side walls 262 that are spaced apart and parallel to one another, and a top wall 264. The side walls 262 and top wall 264 extend generally perpendicularly from the end wall 260. The top wall 264 extends between the top edges of the side walls 262 and the end wall 260. The end wall 260 includes a generally centrally located aperture 266. Each side wall 262 includes an aperture 268 such that the apertures 268 are coaxially aligned with one another. The mounting member 256 also includes a pair of mounting lugs 270. Each mounting lug 270 is generally L-shaped and includes a first leg 272 and a second leg 274 that is generally perpendicular to the first leg 272. Each first leg 272 includes an aperture 276 and each second leg 274 includes a aperture 278. A generally cylindrical shaft 280 having a central axis 282 extends through the apertures 278 in the mounting lugs 270 and through the apertures 268 in the side walls 262 of the bracket 258. The shaft 280 pivotally couples the bracket 258 to the mounting lugs 270 such that the bracket 258 can pivot about the axis 282 with respect to the mounting lugs 270. The first legs 272 of the mounting lugs 270 are adapted to be connected to the first work piece by fasteners or the like. An anti-friction washer 284 may be located between the side walls 262 of the bracket 258 and the second legs 274 of the mounting lugs 270.

The fastener 252 also includes an elongate connector member 290 having a first end 292 and a second end 294. The connector member 290 includes first and second side walls 296 that are spaced apart and generally parallel to one another and that extend from the first end 292 to the second end 294. Each side wall 296 includes an elongate generally linear slot 298. The connector member 290 also includes an end wall 300 at the second end 294 that extends between the side walls 296. The end wall 300 includes a central aperture that is adapted to align coaxially with the aperture 266 in the end wall 260 of the bracket 258. The connector member 290 also includes a top wall 302 that extends from the end wall 300 and between the top edges of the side walls 296 to an edge 304 located generally midway between the first and second ends 292 and 294 of the connector member 290. A bottom wall 306 extends from the end wall 300 along and between the bottom edges of the side walls 296 to an edge 308. The edge 308 is spaced apart from the second end 294 of the connector member 290 and is located closer to the second end 294 than is the edge 304 of the top wall 302. A cavity 310 is formed within the connector member 290 between the side walls 296, top wall 302 and bottom wall 306. A generally cylindrical shaft 312 having a central axis 314 is located at the second end 294 of the connector member 290 and extends between and is coupled to the ends of the side walls 296. The axis 314 is generally coplanar and parallel to the axis 282. The first end 292 of the connector member 290 is adapted to be coupled to the bracket 258 of the mounting member 256 and the second end 294 of the connector member 290 is adapted to be removably attached to a second work piece.

The fastener 252 also includes a latch 320 that is pivotally connected to the shaft 312 of the connector member 290. The latch 320 includes a collar 322 having a generally cylindrical bore through which the shaft 312 of the connector member 290 extends. The shaft 312 pivotally connects the latch 320 to the connector member 290 such that the latch 320 is pivotal about the axis 314 with respect to the connector member 290. The latch 320 also includes a catch member 324 having a first jaw 326, a spaced apart second jaw 328, and a recess 330 located between said jaws 328 and 330. The latch 320 also includes a handle 332 that extends from the collar 322 and catch member 324 to a distal end. The handle 332 includes a receptacle 334 having a hollow chamber.

A locking mechanism 338 is located within the chamber of the housing 334 in the handle 332. The locking mechanism 338 includes a generally cylindrical shaft 340 having a head 342 with a recess 344 at one end, and a pair of diametrically located ears 346 at a second end of the shaft 340. The ears 346 project outwardly beyond the shaft 340 generally perpendicular to the central axis of the shaft 340. An implement such as a coin, screw driver tip, or key may be inserted into the recess 344 of the head 342 to provide rotational movement of the ears 346 about an axis 348. The axis 348 is generally perpendicular to the axes 282 and 314. The ears 346 may be rotated selectively between an unlocked first position wherein the ears 346 do not project outwardly beyond the having 334, and a locked second position located approximately ninety degrees from the unlocked first position wherein the ears 346 project outwardly beyond the housing 334 generally perpendicular to the axis 348. The recess 334 may comprise a keyway in a key lock, such that the ears 346 may only be rotated upon the insertion of an appropriate key into the recess 344.

The fastener 52 also includes a biasing mechanism 354. The biasing mechanism 354 includes an elongate generally cylindrical shaft 356 having a first end 358 and a second end 360. The shaft 356 includes a generally linear central axis 362. The axis 362 is generally coplanar and generally perpendicular to the axes 282 and 314. An enlarged head 364 is attached to the first end 358 of the shaft 356. The second end 360 of the shaft 356 is threaded and is adapted to removably receive a retainer member 366, such as a nut. A locking member 368, such as a locking nut, may also be attached to the second end 360 of the shaft 356. A generally flat or planar circular washer 370 extends around the shaft 356 and is located adjacent the head 364. A generally flat or planar circular washer 372 extends around the shaft 356 and is located adjacent the retainer member 366.

The biasing mechanism 354 also includes one or more resilient biasing members such as generally conical spring washers 374, Belleville washers, wave washers. While the terms “spring washer”, “Belleville washers” and “wave washers” are used it is intended that these terms be broadly defined and interpreted to include, without limitation, a wide range of biasing members. The conical spring washers 374 are constructed and operate in the same manner as the conical spring washers 80A-C. The conical spring washers 374 extend around the shaft 356 and are located between the circular washers 370 and 372, and between the head 364 and retainer member 366. The spring washers 374 may be arranged in an accordion-like manner with an outer peripheral edge of a first washer engaging the outer peripheral edge of an adjacent second washer, or with the inner peripheral edge of a first washer engaging the inner peripheral edge of an adjacent second washer. Two or more of the spring washers 374 may also be arranged in a generally nested manner wherein the annular conical disk of a first washer 374 is generally in engagement with is located within the annular conical disk of an adjacent second washer. As shown in FIG. 15, a plurality of conical spring washers 374 may be used. The number of spring washers 374 that are used and the size and stacking arrangement of the spring washers may be varied as desired such that the spring washers will provide the desired biasing force when compressed. The use of conical spring washers provides a savings in space over the use of a coil spring as a biasing mechanism.

The shaft 356 of the biasing mechanism 354 extends through the aperture 266 in the bracket 258 and through the aperture in the end wall 300 of the connector member 290, such that the shaft 356 couples the first end 292 of the connector member 290 to the mounting member 256. The head 364 of the biasing mechanism 354 is located within the cavity of the bracket 258 of the mounting member 256. The conical spring washers 374, retainer member 366 and locking member 368 are located within the cavity 310 of the connector member 290. The head 364 and washer 370 engage the end wall 260 of the bracket 258, and the spring washers 374 engage the end wall 300 of the connector member 290. The conical spring washers 374 resiliently bias the connector member 290 along the axis 362 toward and into engagement with the end wall 260 of the bracket 258 with a preloaded biasing force. The spring washers 374 also allow the connector member 290 to move along the axis 362 in a direction away from the bracket 258 of the mounting member 256 while compressing the spring washers 374.

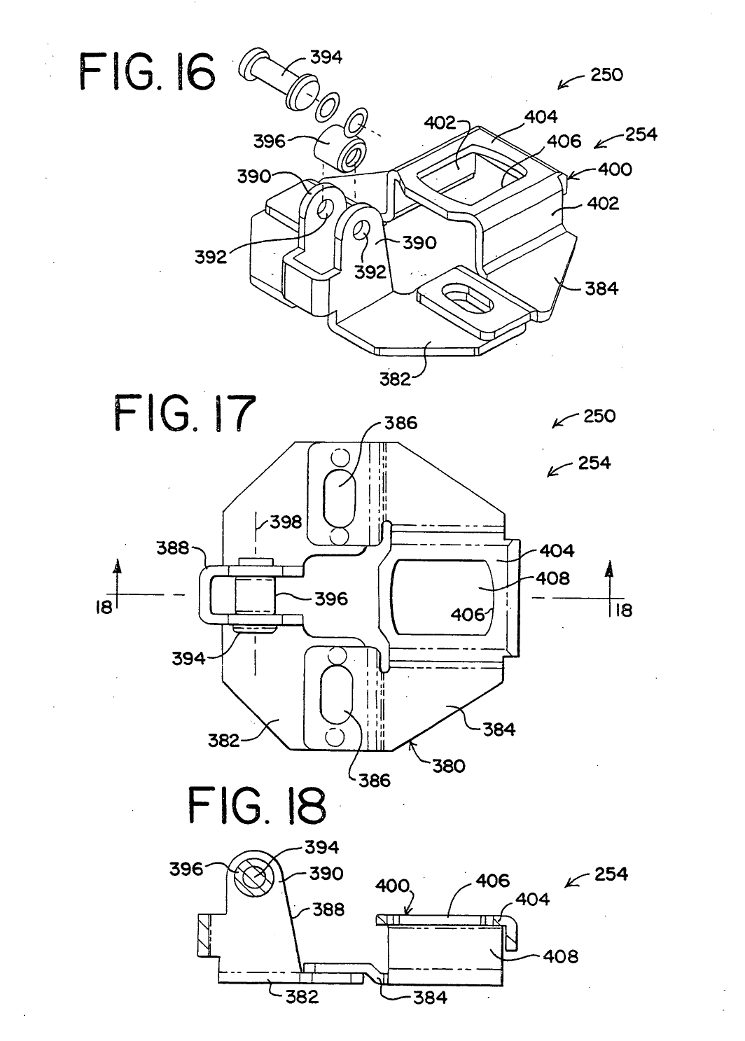

The receptacle 254 as shown in FIGS. 16-18 includes a base 380 having a first plate 382 and second plate 384. A portion of the second plate 384 overlaps a portion of this first plate 382. Apertures 386 extend through the first and second plates 382 and 384. The overlapping portions of the plates 382 and 384 may be attached to one another by fasteners, welding or the like. The base 380 is adapted to be attached to the second work piece. A post 388 extends upwardly from the first plate 382. The upper end of post 388 includes two parallel spaced apart tabs 390. Each tab 390 includes an aperture 392. A shaft 394 extends through the apertures 392 in each of the tabs 390. The shaft 394 includes a head at each end to thereby attach the shaft 394 to the post 388. A generally annular and cylindrical sleeve 396 extends around the shaft 344 and is located between the tabs 390. The sleeve 396 is adapted to be rotatable about a central axis 398 with respect to the post 388. The axis 398 is generally parallel to the axes 282 and 314. A housing 400 is attached to the second plate 384. The housing 400 includes opposing upstanding side walls 402 and a top wall 404 extending between the side walls 402. The top wall 404 includes an aperture 406. A chamber 408 is formed between the side walls 402 and below the top wall 404 that is in communication with the aperture 406.

In operation, the mounting lugs 270 of the mounting member 256 are attached to the first work piece and the base 380 of the receptacle 254 is attached to the second work piece. The latch 320 is rotated about the axis 314 in a clockwise direction as viewed in FIG. 13 to an unlocked first position such that the recess 330 of the catch member 324 is open in a generally downward direction. The bracket 258 of the mounting member 256, connector member 290, and latch 320 are then pivoted about the axis 282 in a generally counter-clockwise direction from a disengaged position to an engaged position wherein the sleeve 396 of the receptacle 254 is located within the recess 330 of the catch member 324. The latch 320 is then rotated further in a generally counter-clockwise direction about the axis 314, with the catch member 324 in engagement with the roller 396, to a locked second position as generally shown in FIG. 13.

When the latch 320 is in the locked position, the roller 396 is located within the recess 320 of the catch member 324 and is in engagement with the catch member 324. The bottom end of the housing 334 extends through the aperture 406 of the housing 400 into the chamber 408 such that the ears 346 of the locking mechanism 338 are located below the top wall 404. As the latch 320 is pivoted from the unlocked position, with the roller 396 located within the catch member 324, toward the locked position, the latch 320 will pull and slide the connector member 290 along the axis 362 away from the bracket 258 of the mounting member 256, thereby compressing the conical spring washers 374 of the biasing mechanism 354. The biasing mechanism 354 thereby biases the receptacle 250 and second work piece into biased engagement with the mounting member 256 and first work piece. When the latch 320 is in the locked position, the axis 362 of the biasing mechanism 354 is located below the axis 398 of the sleeve 396 such that the biasing mechanism 354 will bias the latch 320 about the axis 398 toward the locked position.

When the latch 320 is in the locked position, an implement may be inserted into the recess 344 of the locking mechanism 338 to rotate the ears 346 from an unlocked position approximately ninety degrees to a locked position. When the ears 346 are in the locked position, the ears 346 extend outwardly beyond the housing 334 and beneath the top wall 404 of the housing 400 such that the ears 346 are adapted to engage the top wall 404 to prevent pivotal movement of the latch 320 from its locked position toward its unlocked position.

FIG. 19 shows another embodiment of the fastening system designated with the reference number 420. The fastening system 420 includes a fastener assembly 422 and a receptacle 424. The receptacle 424 operates in the same manner as the receptacle 22 and is constructed in generally the same manner as the receptacle 22 such that like elements are shown with the same reference numbers. The receptacle 424 differs from the receptacle 22 in that the receptacle 424 includes a peripheral wall 426 that extends transversely between the flange 68 and the base member 48. As shown in FIG. 19, the receptacle 424 is adapted to be attached to the second surface 32 of the first work piece 28.

The fastener assembly 422 includes a keeper member 430 and a fastener 432. The keeper member 430 includes a holder 434 attached to a flange 436. The flange 436 is adapted to be attached to the first surface 38 of the second work piece 36. The holder 434 includes a generally circular end wall 438 and a peripheral side wall 440 that extends around the perimeter of the end wall 438 and that extends between the end wall 438 and the flange 436. The sidewall 440 includes a generally conical-shaped side wall portion 442 that extends downwardly and inwardly from the flange 446. The end wall 438 of the holder 434 includes a generally circular aperture 444. The end wall 438 and side wall 440 of the holder 434 form a hollow chamber 446.

The fastener 442 includes a head 450 having a recess 452. As shown in FIG. 19, the head 450 is adapted to be countersunk and includes a generally planar top surface and a generally conical-shaped bottom surface 454. The bottom surface 454 is adapted to matingly engage with the conical side wall portion 442 of the holder 434.

The fastener 432 also includes a body 458 having a first end 460, a second end 462 and a central longitudinal axis 464. The second end 462 of the body 458 is attached to the head 450. The body 458 includes a shank 466 and an engagement member 468. The shank 466 is located between the head 450 and the engagement member 468. The shank 466 has a generally cylindrical peripheral surface 470 that extends concentrically about the axis 464. As shown in FIG. 19, the shank 466 is adapted to extend through the aperture 444 in the end wall 438 of the keeper member 430 and is adapted to fit closely within the aperture 444. The engagement member 468 includes a generally conical-shaped lip 472 that extends outwardly from the cylindrical surface 470 of the shank 466. The lip 472 includes an outer rim 474. The lip 472 is located adjacent the first end 460 of the body 458. The body 458 also includes a pair of opposing spiral cam slots 476 that extend from the second end 462 toward the first end 460 of the body 458. The spiral slots 476 extend into the engagement member 468 and the shank 466.

The shank 466 has a diameter that is smaller than the diameter of the aperture 444, while the engagement member 468 and the head 450 have respective diameters that are larger than the diameter of the aperture 444, such that neither the head 450 nor the engagement member 468 can pass through the aperture 444. The shank 466 can slidably move along the axis 466 within the aperture 444 and with respect to the keeper member 430. The engagement member 468 has a diameter that is smaller than the diameter of the interior surface of the side wall 58 of the housing 56 of the receptacle 424, but that is sized to locate the engagement member 468 closely adjacent to the side wall 58 such that the side wall 58 will guide insertion of the engagement member 468 and will prevent substantial lateral movement of the engagement member 468. The fastener 432, when not connected to the receptacle 424, is rotatable about the axis 464 with respect to the keeper member 430 and is slidably movable along the axis 464 with respect to the keeper member 430 between an extended position as shown in FIG. 19, wherein the head 450 engages the keeper member 430, and a fully retracted position wherein the engagement member 468 engages the end wall 438 of the keeper member 430.

The fastener assembly 422 also includes a resilient biasing member 480 having a first end 482 and a second end 484. The biasing member 480 is located within the chamber 446 of the holder 434 and extends generally concentrically about the shank 466 of the fastener 432. The first end 482 of the biasing member 480 engages the end wall 438 of the holder 434 and the second end 484 of the biasing member 480 engages the bottom surface 454 of the head 450 of the fastener 432. The biasing member 480 may comprise a helical coil spring. The biasing member 480 resiliently biases the fastener 432 to slidably move along the axis 464 from an extended position as shown in FIG. 19, wherein the head 450 of the fastener 432 is in engagement with the keeper member 430, and a retracted position wherein the head 450 of the fastener 432 is spaced apart from the keeper member 430.

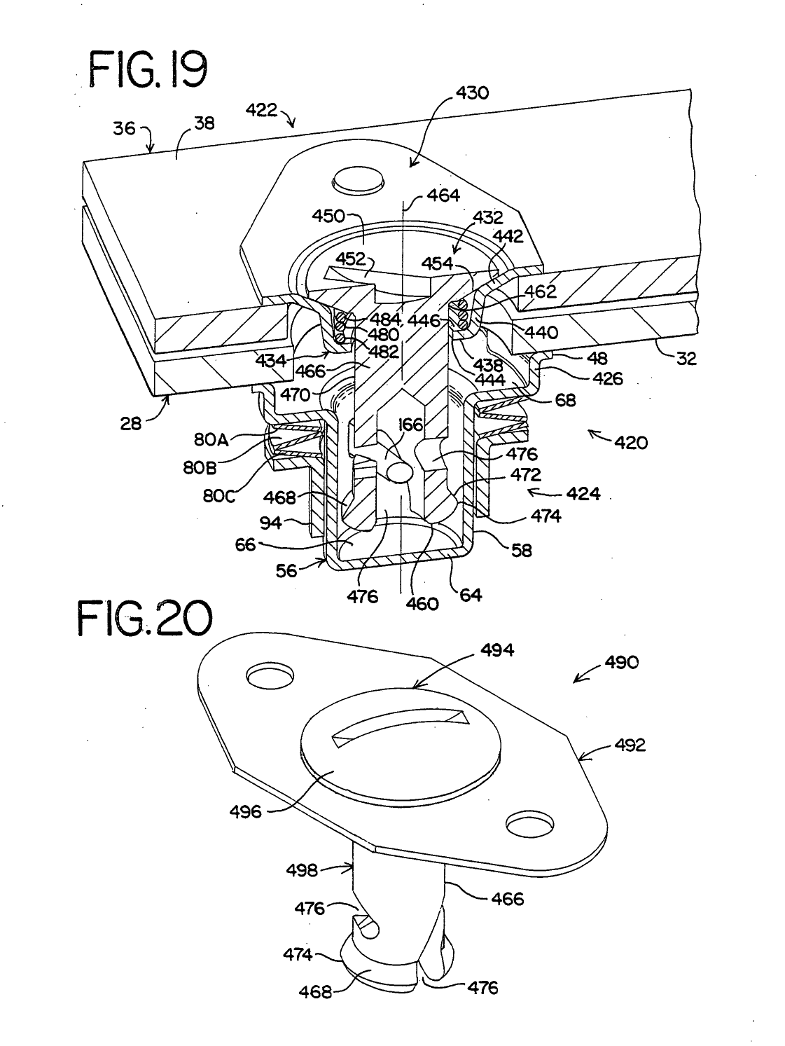

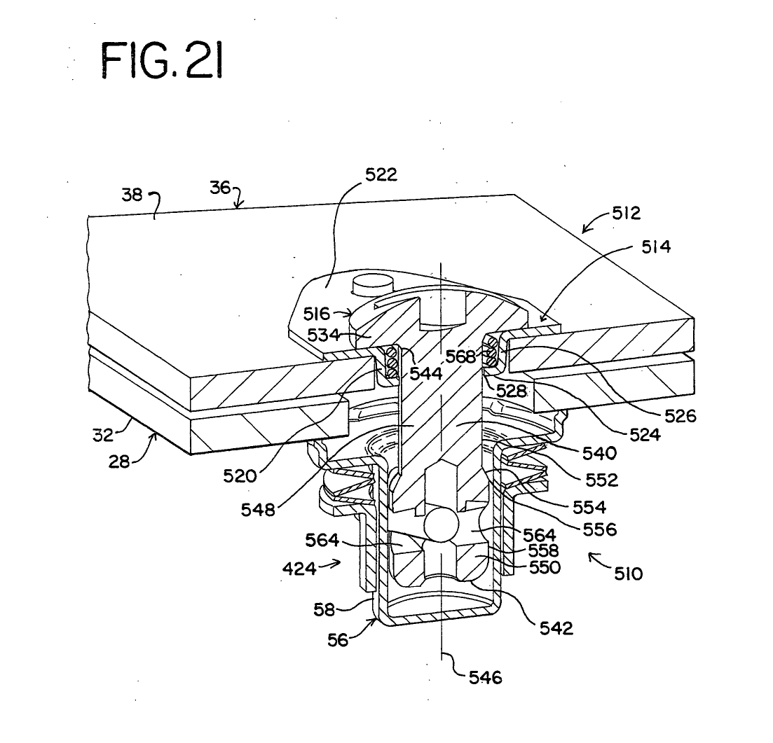

FIG. 20 shows a fastener assembly 490 including a keeper member 492 and a fastener 494. The fastener 494 includes a head 496 and a body 498 attached to the head 496. The body 498 is constructed and operates in the same manner as the body 458 of the fastener 432. The head 496 of the fastener 494 includes a generally spherical top surface and a generally planar bottom surface that is adapted to engage the keeper member 492.

FIG. 21 shows another embodiment of the fastening system designated with the reference number 510. The fastening system 510 includes a fastener assembly 512 having a keeper member 514 and a fastener 516. The fastener 516 is adapted to be removably attached to a receptacle 424. The keeper member 514 includes a holder 520 attached to a flange 522. The flange 522 is adapted to be attached to the first surface 38 of the second work piece 36. The holder 520 includes a generally circular and planar end wall 524 and a generally cylindrical peripheral wall 526 that extends around the end wall 524 and that extends between the end wall 524 and the flange 522. The end wall 524 includes a generally circular aperture 528.

The fastener 516 includes a head 534 having a generally planar bottom surface adapted to engage the flange 522 of the keeper member 514, and a generally spherical top surface including a recess.

The fastener 516 also includes a body 540 having a first end 542, a second end 544 and a central longitudinal axis 546. The second end 544 of the body 540 is attached to the head 534. The body 540 includes a shank 548 and an engagement member 550. The shank 548 is located between the head 534 and the engagement member 550 and extends through the aperture 528. The shank 548 includes a generally cylindrical surface 552 that extends from the head 534 to the engagement member 550 and that extends generally concentrically about the axis 546. The engagement member 550 includes a generally conical lip 554 having a generally circular rim 556 that extends generally concentrically about the axis 546. The engagement member 550 also includes a generally cylindrical surface 558 that extends from the rim 556 to a position adjacent the first end 542 of the body 540.

The body 540 also includes a pair of spiral cam slots 564 that extend inwardly from the first end 542 of the body 540. The spiral slots 546 are located between the lip 554 of the engagement member 550 and the first end 542 of the body 540. The spiral slots 564 do not extend into the shank 548.

The rim 556 and the cylindrical surface 558 have a diameter that is larger than the diameter of the aperture 528 such that the engagement member 550 will not pass through the aperture 528, but that is smaller than the diameter of the internal surface of the side wall 58 of the housing 56 of the receptacle 424 such that the rim 556 and cylindrical surface 558 will be located closely adjacent to the internal surface of the housing 56. The diameter of the head 534 is also larger than the diameter of the aperture 528 such that the head 534 will not pass through the aperture 528. The shank 548 of the fastener 516 has a diameter that is smaller than the diameter of the aperture 528 such that the shank 548 is linearly movable along the axis 546 within the aperture 528 and with respect to the keeper member 514.

The fastener assembly 512 includes a resilient biasing member 568. The biasing member 568 is located within the chamber of the holder 520 and extends around the shank 548 of the fastener 516. The biasing member 568 includes a first end in engagement with the end wall 524 of the holder 520 and a second end in engagement with the bottom surface of the head 534 of the fastener 516. The biasing member may be a resilient helical coil spring. The biasing member 568 resiliently biases the fastener 516 from an extended position as shown in FIG. 21, wherein the fastener 516 is attached to the receptacle 424 and the head 534 of the fastener 516 is in engagement with the keeper member 514, toward a retracted position wherein the fastener 516 is released from the receptacle 424 and the head 534 of the fastener 516 as spaced apart from the keeper member 514. The biasing member 568 may resiliently bias the lip 554 of the engagement member 550 in engagement with the end wall 524 of the holder 520 when the fastener 516 is in the fully retracted position.

Various features of the fastening system have been particularly shown and described in connection with the illustrated embodiments of the disclosure, however, it must be understood that these particular arrangements merely illustrate, and that the fastening system is to be given its fullest interpretation within the terms of the appended claims.

1. A fastening system for removably attaching a first work piece in biased engagement with a second work piece having an aperture, the fastening system comprising:
a receptacle having a central axis and a side wall forming a chamber, the side wall extending between a first end and a second end, the side wall including one or more apertures, a cap extending around the side wall and being selectively slidable along the central axis with respect to the side wall, a retainer member extending through the one or more apertures in the side wall and slidably coupling the cap to the side wall, the retainer member being movable within the one or more apertures of the side wall such that the retainer member and the cap are selectively conjointly slidable along the central axis between an extended position and a retracted position, and one or more biasing members extending around the side wall, each biasing member comprising a generally conical-shaped spring washer, the biasing members resiliently biasing the retainer member and the cap toward the extended position, the receptacle adapted to engage the first work piece; and
a fastener including a head and a body attached to the head, the body including a spiral slot adapted to selectively receive and retain the retainer member, the body of the fastener adapted to be inserted through the aperture of the second work piece and into the chamber of the receptacle wherein the retainer member is adapted to be located within the spiral slot of the body, whereby when the fastener is rotated, the spiral slot of the body slides the retainer member and the cap from the extended position toward the retracted position thereby connecting the second work piece to the first work piece and compressing the biasing members, the biasing members thereby providing a resilient biasing force for biasing the second work piece in engagement with the first work piece.

2. The fastening system of claim 1 wherein the one or more apertures of the side wall comprise a first aperture and a second aperture, the first and second apertures being located in the side wall generally diametrically opposite one another.

3. The fastening system of claim 2 wherein the first aperture comprises an elongate first slot and the second aperture comprises an elongate second slot, the first and second slots being elongate between a first end and a second end in a direction generally parallel to the central axis of the receptacle.

4. The fastening system of claim 1 wherein the cap includes a side wall having a first end and a second end, the cap side wall extending around the side wall of the receptacle, the cap side wall including a first aperture and a second aperture, each first and second aperture of the cap side wall adapted to align with a respective aperture in the side wall of the receptacle.

5. The fastening system of claim 4 wherein the retainer member extends through the first and second apertures of the cap side wall.

6. The fastening system of claim 5 wherein the first and second apertures of the cap side wall respectively comprise first and second generally keyhole-shaped slots, each keyhole-shaped slot having an enlarged portion and a reduced portion, the reduced portion being located toward the first end of the cap side wall and the enlarged portion being located toward the second end of the cap side wall.

7. The fastening system of claim 6 wherein the retainer member includes a first end having a first locking member and a second end, the first end of the retainer member being located in the first keyhole-shaped slot of the cap side wall and the second end of the retainer member being located in the second keyhole-shaped slot of the cap side wall, the first locking member preventing movement of the retainer member transversely to the central axis of the receptacle when the first end of the retainer member is located in the reduced portion of the first keyhole-shaped slot, the retainer member being movable with respect to the cap in a direction transverse to the central axis when the first and second ends of the retainer member are located within the enlarged portions of the first and second keyhole-shaped slots of the cap side wall.

8. The fastening system of claim 7 wherein the retainer member comprises a pin and the first locking member comprises a groove formed in the pin, the pin including a second locking member at the second end of the pin, the second locking member comprising a groove formed in the pin.

9. The fastening system of claim 1 wherein each conical-shaped spring washer includes a generally conical-shaped annular disc, the annular disc including a generally circular inner peripheral edge and a generally circular outer peripheral edge.

10. The fastening system of claim 9 wherein the inner peripheral edge of a first biasing member is in engagement with the inner peripheral edge of a second biasing member.

11. The fastening system of claim 9 wherein the biasing members are arranged in a generally accordion-like manner.

12. The fastening system of claim 1 including a flange attached to the first end of the side wall of the receptacle, and a base member attached to the flange, the base member adapted to be attached to the first work piece.

13. The fastening system of claim 1 including a base member attached to the first end of the side wall of the receptacle, the base member including one or more legs extending outwardly from the side wall of the receptacle, each leg including an aperture.

14. The fastening system of claim 1 wherein the body of the fastener includes a transverse bore forming a detent cavity, a detent member located within the detent cavity, and a biasing member located within the bore, the biasing member resiliently biasing the detent member to an extended position wherein the detent member extends outwardly beyond the body of the fastener, the detent member being selectively movable from the extended position toward a retracted position.

15. The fastening system of claim 14 including a seat formed between the head of the fastener and the detent member when the detent member is located in the extended position, the seat adapted to receive the second work piece.

16. The fastening system of claim 14 wherein the detent cavity of the fastener includes a lip adapted to retain the detent member within the detent cavity.

17. A receptacle for a fastening system adapted to selectively receive and retain a fastener, the receptacle comprising:
a housing including a central axis and a side wall forming a chamber, the side wall extending between a first end and a second end, the side wall including one or more apertures;
a cap extending around the side wall of the housing, the cap being selectively slidable along the central axis with respect to the side wall of the housing;
a retainer member located in the chamber of the housing and extending through the one or more apertures in the side wall of the housing, the retainer member slidably coupling the cap to the side wall of the housing, the retainer member being movable within the apertures of the side wall of the housing such that the retainer member and the cap are selectively conjointly slidable along the central axis between an extended position and a retracted position; and
one or more biasing members-extending around the side wall of the housing, the biasing members resiliently biasing the retainer member and the cap toward the extended position;
whereby the chamber of the housing is adapted to receive the fastener such that the fastener may releasably engage the retainer member, whereupon the biasing members are adapted to resiliently bias the retainer member, the cap, and the fastener toward the extended position of the retainer member and the cap.

18. The receptacle of claim 17 wherein the one or more apertures of the side wall comprise a first aperture and a second aperture, the first and second apertures being located in the side wall generally diametrically opposite one another.

19. The receptacle of claim 18 wherein the first aperture comprises an elongate first slot and the second aperture comprises an elongate second slot, the first and second slots being elongate between a first end and a second end in a direction generally parallel to the central axis of the receptacle.

20. The receptacle of claim 17 wherein the cap includes a side wall having a first end and a second end, the cap side wall extending around the side wall of the receptacle, the cap side wall including a first aperture and a second aperture, each first and second aperture of the cap side wall adapted to align with a respective aperture in the side wall of the receptacle.

21. The receptacle of claim 20 wherein the retainer member extends through the first and second apertures of the cap side wall.

22. The receptacle of claim 21 wherein the first and second apertures of the cap side wall respectively comprise first and second generally keyhole-shaped slots, each keyhole-shaped slot having an enlarged portion and a reduced portion, the reduced portion being located toward the first end of the cap side wall and the enlarged portion being located toward the second end of the cap side wall.

23. The receptacle of claim 22 wherein the retainer member includes a first end having a first locking member and a second end, the first end of the retainer member being located in the first keyhole-shaped slot of the cap side wall and the second end of the retainer member being located in the second keyhole-shaped slot of the cap side wall, the first locking member preventing movement of the retainer member transversely to the central axis of the receptacle when the first end of the retainer member is located in the reduced portion of the first keyhole-shaped slot, the retainer member being movable with respect to the cap in a direction transverse to the central axis when the first and second ends of the retainer member are located within the enlarged portions of the first and second keyhole-shaped slots of the cap side wall.

24. The receptacle of claim 23 wherein the retainer member comprises a pin and the first locking member comprises a groove formed in the pin, the pin including a second locking member at the second end of the pin, the second locking member comprising a groove formed in the pin.

25. The receptacle of claim 17 wherein each biasing member comprises a generally conical-shaped spring washer having a generally conical-shaped annular disc, the annular disc including a generally circular inner peripheral edge and a generally circular outer peripheral edge.

26. The receptacle of claim 25 wherein the inner peripheral edge of a first biasing member is in engagement with the inner peripheral edge of a second biasing member.

27. The receptacle of claim 25 wherein the biasing members are arranged in a generally accordion-like manner.

28. The receptacle of claim 17 including a flange attached to the first end of the side wall of the receptacle, and a base member attached to the flange, the base member adapted to be attached to the first work piece.

29. The receptacle of claim 17 including a base member attached to the first end of the side wall of the receptacle, the base member including one or more legs extending outwardly from the side wall of the receptacle, each leg including an aperture.

30. The receptacle of claim 17 wherein the housing includes an end wall attached to the second end of the side wall of the housing.

31. The receptacle of claim 17 wherein the cap includes a flange attached to and extending outwardly from an end of the side wall of the cap.

32. A fastener adapted to be selectively received and retained in a receptacle of a fastening system having a retainer member, the fastener comprising:
a head;
a body having a first end, a second end and a central longitudinal axis, the second end being attached to the head, the body including a first spiral slot adapted to selectively receive and retain the retainer member of the receptacle, a transverse bore having a transverse axis extending into the body, the transverse bore forming a detent cavity, a detent member located within the detent cavity, the detent member being movable between an extended position wherein a portion of the detent member extends outwardly from the body and a retracted position, and a biasing member located within the transverse bore, the biasing member resiliently biasing the detent member toward the extended position.

33. The fastener of claim 32 including a seat formed between the head of the fastener and the detent member when the detent member is located in the extended position, the seat adapted to receive and retain a work piece, the detent member being selectively movable to the retracted position such that the work piece can be removed from the seat.

34. The fastener system of claim 32 wherein the detent cavity of the fastener includes a lip adapted to retain the detent member within the detent cavity.

35. The fastener of claim 32 including a longitudinal bore extending into the body along the central longitudinal axis, the longitudinal bore being in communication with the transverse bore.

36. The fastener of claim 35 wherein the transverse bore forms an internal pocket in the body, the internal pocket adapted to receive an end of the biasing member.

37. The fastener of claim 32 wherein the biasing member comprises a coil spring.

38. The fastener of claim 32 wherein the head includes a recess adapted to receive a tool.

39. The fastener of claim 32 including a second spiral slot.

40. The fastener of claim 32 wherein the transverse bore is located between the head and the first spiral slot.

41. A method of attaching a first work piece having a first aperture in biased engagement with a second work piece having a second aperture, the steps of the method comprising:
providing a receptacle having a central axis and a side wall forming a chamber, the side wall including one or more apertures, a cap extending around the side wall and being selectively slidable along the central axis with respect to the side wall, a retainer member extending through the one or more apertures in the side wall slidably coupling the cap to the side wall, the retainer member being movable within the apertures of the side wall such that the retainer member and the cap are selectively conjointly slidable along the central axis between an extended position and a retracted position, and one or more biasing members extending around the side wall, the biasing members resiliently biasing the retainer member and the cap toward the extended position;
locating the chamber of the receptacle adjacent the first aperture in the first work piece;
providing a fastener including a head and a body attached to the head, the body including a spiral slot adapted to selectively receive and retain the retainer member of the receptacle;
inserting the fastener through the second aperture in the second work piece, through the first aperture in the first work piece, and into the chamber of the receptacle such that the retainer member is located within the spiral slot of the fastener;
rotating the fastener such that the spiral slot of the fastener slides the retainer member and the cap from the extended position toward the retracted position thereby connecting the second work piece to the first work piece and compressing the biasing members, the biasing members thereby providing a resilient biasing force for biasing the second work piece in engagement with the first work piece.

42. The method of claim 41 wherein each biasing member comprises a generally conical-shaped washer.

43. A method of preloading a receptacle of a fastener system with a selected preload biasing force, the steps of the method comprising:
providing a receptacle having a central axis and a housing having a side wall forming a chamber, the side wall including one or more apertures, a cap extending around the side wall and being selectively slidable along the central axis with respect to the side wall, a retainer member extending through the one or more apertures in the side wall slidably coupling the cap to side wall, the retainer member being movable within the apertures of the side wall such that the retainer member and the cap are selectively conjointly slidable along the central axis between an extended position and a retracted position, and
providing one or more biasing members extending around the side wall, the biasing members resiliently biasing the retainer member and the cap toward the extended position with a preload biasing force.

44. The method of claim 43 including the step of selecting the number of biasing members that are provided to thereby adjust the magnitude of the preload biasing force.

45. The method of claim 43 including the step of selecting the size of each biasing member to thereby adjust the magnitude of the preload biasing force.

46. The method of claim 43 wherein each biasing member comprises a generally conical-shaped washer.

47. A fastening system for removably attaching a first work piece to a second work piece, the fastening system comprising:
a mounting member adapted to be attached to the first work piece;
a connector member having a first end and a second end, the first end adapted to be coupled to the mounting member and the second end adapted to be removably attached to the second work piece, the connector member being movable with respect to the mounting member between a first position and a second position, the connector member adapted to be attached to the second work piece in the second position; and
a biasing mechanism including an elongate shaft coupling the first end of the connector member to the mounting member, and one or more biasing members extending around the shaft, each biasing member comprising a generally conical-shaped spring washer;
whereby the biasing members of the biasing mechanism are adapted to resiliently bias the connector member from the second position toward the first position.

48. The fastening system of claim 47 including a latch member coupled to the second end of the connector member, and a receptacle adapted to be attached to the second work piece, the latch member adapted to removably attach the connector member to the receptacle.

49. The fastening system of claim 47 wherein the shaft of the biasing mechanism includes a first end adapted to be coupled to the mounting member and a second end adapted to be coupled to the connector member.

50. The fastening system of claim 49 wherein the biasing members are located between the second end of the shaft and the connector member.

51. A biasing mechanism for a fastening system having a mounting member adapted to be attached to a first work piece and a latch member adapted to be removably attached to a second work piece, the biasing mechanism comprising:
an elongate shaft having a first end and a second end, the first end adapted to be coupled to the mounting member and the second end adapted to be coupled to the latch member such that the latch member is movable with respect to the mounting member between a first position and a second position; and
one or more biasing members extending around the shaft, each biasing member comprising a generally conical-shaped spring washer, the biasing members adapted to be resiliently compressed as the latch member moves from the first position toward the second position such that the biasing members resiliently bias the latch member from the second position toward the first position.

52. The biasing mechanism of claim 51 including a plurality of generally conical-shaped spring washers, each conical-shaped spring washer including a generally conical-shaped annular disc, the annular disc including a generally circular inner peripheral edge and a generally circular outer peripheral edge.

53. The biasing mechanism of claim 52 wherein two or more of the conical-shaped spring washers are arranged in a generally accordion-like manner.

54. The biasing mechanism of claim 53 wherein two or more of the conical-shaped spring washers are arranged in a generally nested manner.

55. The biasing mechanism of claim 52 wherein two or more of the conical-shaped spring washers are arranged in a generally nested manner.

56. The biasing mechanism of claim 51 including a head connected to the first end of the shaft and a retainer member removably attached to the second end of the shaft.

57. A fastener assembly adapted to be attached to a work piece, the fastener assembly comprising:
a keeper member adapted to be attached to the work piece, the keeper member including an aperture; and
a fastener including a head and a body, the body including a first end, a second end and a central axis, the second end of the body attached to the head, the body including a shank and an engagement member, the shank being located between the head and the engagement member, the shank extending through the aperture of the keeper member;
whereby the shank is movable within the aperture of the keeper member such that the fastener is movable with respect to the keeper member along the axis of the body, and the head and the engagement member are adapted to engage the keeper member and thereby retain the fastener within the aperture of the keeper member and to prevent removal of the fastener from the keeper member.

58. The fastener assembly of claim 57 wherein the keeper member includes a holder having an end wall and a peripheral side wall forming a chamber, the aperture located in the end wall of the holder.

59. The fastener assembly of claim 58 including a resilient biasing member located in the chamber of the holder, the biasing member having a first end in engagement with the holder and a second end in engagement with the head of the fastener, the biasing member adapted to bias the head of the fastener in a direction away from the holder.

60. The fastener assembly of claim 59 wherein the biasing member comprises a coil spring, the spring extending around the body of the fastener.

61. The fastener assembly of claim 59 wherein the biasing member is adapted to resiliently bias the engagement member of the fastener into engagement with the holder.

62. The fastener of claim 58 including a flange attached to the holder, the flange adapted to be attached to the work piece, and wherein the side wall of the holder includes a conical-shaped wall section attached to the flange, the conical-shaped wall section adapted to receive the head of the fastener.

63. The fastener assembly of claim 57 wherein the engagement member extends in a direction transverse to the axis outwardly beyond the shank.

64. The fastener assembly of claim 57 wherein the engagement member includes a lip that extends outwardly from the shank.

65. The fastener assembly of claim 64 wherein the engagement member includes a peripheral side wall extending from the lip toward the first end of the body, the peripheral side wall having a diameter that is larger than the diameter of the shank.

66. The fastener assembly of claim 57 wherein the first end of the body of the fastener includes a spiral slot adapted to receive and retain a retainer member.

67. A fastener adapted to be retained by a keeper member having an aperture, the fastener comprising:
a head;
a body having a first end, a second end, and a central axis, the second end of the body attached to the head, the body including a shank and an engagement member, the shank being located between the head and the engagement member, the shank adapted to extend through the aperture of the keeper member, the engagement member extending transversely to the axis outwardly beyond the shank;
whereby the shank is adapted to be movable within the aperture of the keeper member such that the fastener is movable along the central axis with respect to the keeper member, and the head and the engagement member are adapted to engage the keeper member and thereby retain the fastener within the aperture of the keeper member and prevent removal of the fastener from the keeper member.

68. The fastener of claim 67 wherein the engagement member includes a lip extending outwardly from the shank.

69. The fastener of claim 68 wherein the lip extends around the central axis of the body.

70. The fastener of claim 67 wherein the shank includes a peripheral surface extending generally concentrically about the central axis, and the engagement member includes a peripheral surface extending generally concentrically about the central axis, the peripheral surface of the engagement member being spaced further from the central axis than the peripheral surface of the shank is spaced from the central axis.

71. The fastener of claim 67 including a spiral slot at the first end of the body adapted to receive a retainer member.

72. The fastener of claim 71 wherein the shank is spaced apart from the spiral slot.

73. The fastener of claim 71 wherein the spiral slot extends into the engagement member and the shank.
